(19) United States
(12) Patent Application Publication
(10) Pub. No.: US 2003/0233272 A1
(43) Pub. Date: Dec. 18, 2003

(54) Method of identifying new market opportunities

(76) Inventors: Simona Rocchi, Eindhoven (NL); Christina Lindsay, Eindhoven (NL)

Correspondence Address: Corporate Patent Counsel;, U.S. Philips Corporation;, 580 White Plains Road, Tarrytown, NY, 10591, US

(21) Appl. No.: 10/445,527

(22) Filed: May 27, 2003

(30) Foreign Application Priority Data
May 30, 2002 (EP) 02077129.1

(51) Int. Cl. G06F 17/60

(52) U.S. Cl. 705/10

(57) ABSTRACT

A method of identifying new market opportunities, comprising

determining a subject for research based on the market in which said opportunities are to be identified,

inviting individual persons to participate in the research regarding the subject,

training the individual persons to perform a self-study regarding the subject,

letting the individual persons perform the self-study for a certain period of time,

receiving respective reports from the individual persons on their respective self-studies,

producing a matrix linking issues identified in the previous steps to people clusters derived from characteristics of the individual persons, and deriving the new market opportunities by comparing the problems identified across the linked issues and people clusters in the matrix.

### FIELD OF THE INVENTION

The invention relates to consumer and market research, and more particular to linked research and design processes for the creation of new competitive product-service mixes which lead to added-value solutions.

### BACKGROUND OF THE INVENTION

The mass marketing model, established in the developed Western Europe and the USA by the 1950's and 1960's, implied similarity of product preferences and product usage patterns with large consumer groups. Consumer “segments” were shaped based on major socio-demographic variables, such as gender, age, and income; price was one of the major market differentiator.

By the 1970's a different marketing models and practices were established, with the market segments increasingly shaped on a base of education, occupation, residence etc., and lately lifestyle and value systems of people. More sophisticated technologies allowed business to produce products and services more focused on a particular consumer group. To understand these segments better, a variety of consumer research tools were used.

Today, we observe a profound change in human value systems, with a particular emphasis on individualization and personal accomplishments. To respond this quest, businesses are increasingly employ a mass customization approach, leading to one-to-one marketing. This typically involves investigating desires, needs and problems of individual consumers to identify new marketing opportunities. There are many well-documented research methods for such investigations into people's lives—some of which (e.g. design ethnography, contextual research) have been adapted for use in the design field. However, these methods are usually presented individually and not linked together in a research process to provide a flexible framework of varied methods for use in different contexts. In addition, there is very little written on how to translate the information obtained by these research methods for use in the design process.

Various disciplines, such as linguistics, anthropology, psychology, architecture and sociology have analyzed the meaning of ‘context’ focusing on different characteristics and dynamics, generating different perspectives. There is no consensus on what ‘context’ means and nothing on our specific interest of ‘context of use’. See, for example, Akman, Varol, 2000. “Rethinking context as a social construct”, Journal of Pragmatics 32: 743-759; Hillier Bill, Hanson Julienne, 1984, The social logic of space, Cambridge University Press, Cambridge.

There have been attempts to include designers in the research process (empathic design; Leonard, Dorothy, Spark Innovation through Empathic Design) and users in the design process (participatory design; see Schuler, Douglas, Aki Namioka, 1992, Participatory Design: Principles and Practices, Lawrence Erlbaum Assocs), each of which have met with limited success and each of which addresses only one part of the research and design process. There is nothing published on the integration of researchers, designers and users as co-creators in either the research or design processes.

### SUMMARY OF THE INVENTION

It is an object of the invention to provide a method of identifying new market opportunities, which involves users in the design process as co-creators of the research, and as co-creators of the solutions.

This object is achieved in a method comprising

determining a subject for research based on the market in which said opportunities are to be identified,

inviting individual persons to participate in the research regarding the subject,

training the individual persons to perform a self-study regarding the subject,

letting the individual persons perform the self-study for a certain period of time,

receiving respective reports from the individual persons on their respective self-studies in specific locations at specific times,

producing a matrix linking issues identified in the previous steps to people clusters derived from characteristics of the individual persons in the specific locations and at the specific times, and

deriving the new market opportunities by comparing the problems identified across the linked issues and people clusters in the matrix.

The inventors' challenge was to develop a practical methodological approach able to combine the benefits of short-term traditional consumer research techniques with new emerging long-term investigation methods. An approach able to catch personal user's preferences, wants and desires in their original contexts of use, in such a way to be:

a repeatable process (precise but flexible enough for adaptation);

a relatively cheap process (in terms of people and time involved);

a relatively easy-of-use process (not particular expertise in ethnography but enough sensitiveness and skills to address a social analyses);

a process for the empowerment of the user (enabling his/her participation by self-reporting activities);

a process providing immediately available information for inspiring designers during their creative process for concepts generation.

The invention takes an ethnographic perspective, being concerned with people's everyday lives and their interaction with the research subject. The invention makes it possible to collect different kinds of information (from that of traditional segmentation) and to do this through establishing dynamic, interactive, longer-term relationships with the users. This is not ethnography, but a combination of observation of, and conversation with, the users in their everyday lives and of the users themselves acting as researchers.

At a particular time, an action takes place in a specific environment, which is the result of a continuous tension among social-cultural, physical and psychological components. The social-cultural component concerns to set of values and norms shared by certain number of people. The physical component concerns the organization of the space where an action takes place. The psychological component stands for the individual's perception and interpretation of the physical and socio-cultural components. This is referred to as the context of use (CoU).

The research methodology approach consists of two parts:

1. The key to the entire process is a multi-disciplinary perspective in which researchers, designers and the users themselves work together as a team to co-create both the research and the design.

2. The physical element of the context of use is used, in the formal maps which record needs and wants to time and space, as a way to obtain information about the personal and the social components. Information is collected about actors, activities, actions and artifacts.

The training can be given in a variety of ways. In a first preferred embodiment, referred to as a broad research path, the training comprises spending a period of time with the user to prepare the user to perform the self-study, focusing on one or more activities related to the subject. The broad research path is best suited for situations in which a short throughput time is desired, a lot of users are involved, and so on.

In another preferred embodiment, referred to as a deep research path, the training comprises collecting background information about the user's relationship with the subject, and spending an extended period of time with the user to prepare the user to perform the self-study. The deep research path takes more time, but it provides much more information.

The users should preferably present their respective reports in the form of narratives told by the individual persons. The reports should comprise documentation collected during the certain period of time in which the self-study was performed.

Other advantageous embodiments are set out in the dependent claims.

### BRIEF DESCRIPTION OF THE FIGURES

These and other aspects of the invention will be apparent from and elucidated with reference to the embodiments shown in the drawings, in which:

FIG. 1 is a flowchart illustrating the method according to the invention;

FIG. 2 shows a Context of Use (CoU) matrix as produced in step 108 of the method of FIG. 1;

FIG. 3 gives some examples of maps drawn or used by the users and researchers;

FIG. 4 illustrates an example report of a “day in the life of” a user participating in the method according to the invention;

FIG. 5 shows example issues obtained through the reports made by users and the research conducted; and

FIG. 6 shows how the example issues of FIG. 5 can be presented in the CoU matrix of FIG. 2 to facilitate easy comparison of data and derivation of market opportunities.

Throughout the Figures, same symbols or reference numerals indicate similar or corresponding features.

### DETAILED DESCRIPTION

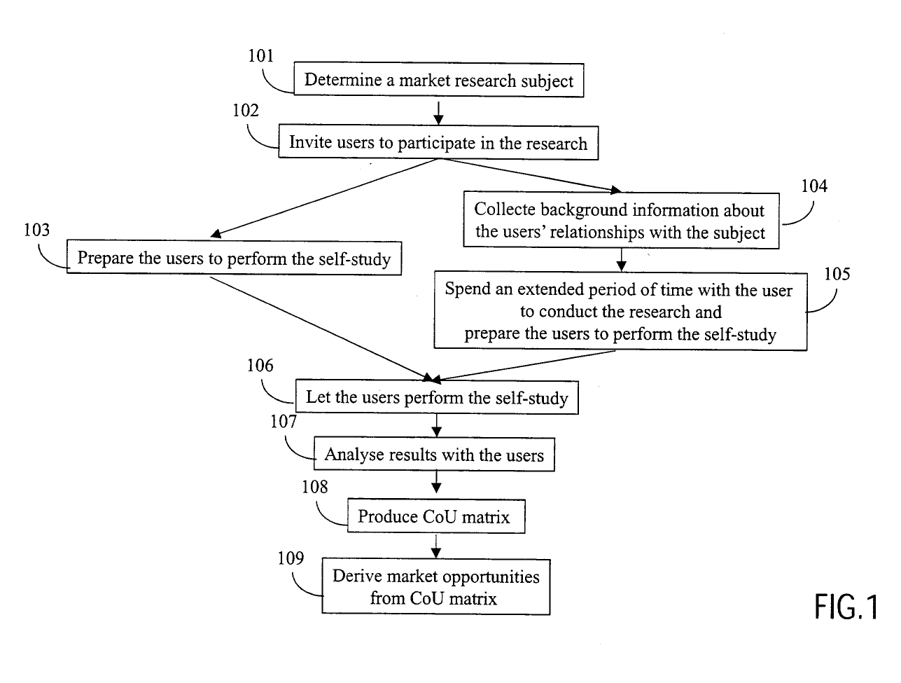

FIG. 1 is a flowchart illustrating the method according to the invention. The goal is to move towards involving users in the design process as co-creator of the research, both in collecting the data and in analyzing it. The users should also be co-creators of the solutions obtained by the method. This approach recognizes that users are experts in their own lives.

### GETTING STARTED

The first step 101 comprises determining a subject for research based on the market in which new market opportunities are to be identified. Typically the subject is determined based on an assignment made by a client, which can be for example a CE manufacturer seeking to expand its business. However, one should not merely accept the assignment as given by the client, but instead try to get a proper definition of the subject of the research with focus on the users' needs and contexts of use.

After the research subject has been determined, the next step is to find appropriate research sites and research subjects (users) within the intended contexts of use. One should look for relevant organizations, institutions and services e.g. through telephone directories, the Internet or relevant publications.

The individual persons that meet the criteria are then invited, in step 102, to participate in the research project. Part of this step is to provide an explanation of the research process to the user and to obtain the user's agreement to participate. This step should be more than just making a phone call and getting the user to sign a form. If the method is to work effectively, a relationship between the users and the researchers should be established. To start to establish this relationship, one might want to consider a personal interview with the user in which information about the user's backgrounds is exchanged. The users should also be informed in advance about any incentives or presents they might receive in return for participating in the research.

In addition, the issue of informed consent is raised with the users in explaining to them their rights as research participants. This involves user rights like the right to confidentiality and anonymity if they require, the right to withdraw from the project at any time or to remove any of their contributions, and the right to be asked at a later date if we wish to use photos of them in any report or publication.

### CONDUCTING THE RESEARCH

After a sufficient number of users willing to participate has been found, it is time to begin to conduct the research. There are various ways in which this can be done. FIG. 1 illustrates two such ways: step 103 on the one hand, and steps 104 and 105 on the other hand. The respective steps represent alternative research paths: a broad research path, step 103, and a deep research path, steps 104 and 105. An important element of this is training these participating users to perform a self-study regarding the research subject. This training is accomplished throughout the research process by showing the user how the researcher herself is conducting the research and inviting the user to participate directly and to ask questions.

At the end of the research sessions prior to the self-study period, the researcher explicitly instructs the users in what is expected of them and answers any questions or concerns that the users may have. It is important to emphasize to the user that there are no right or wrong answers, not any right or wrong way of conducting the research. What is important is to get an insight into the users' lives from their points of view.

Broad research path

Included in the research conducted in step 103 is a period of spending time with the user to prepare the user to perform the self-study, focusing on one or more activities related to the subject. A researcher spends two or three hours with the user, focusing on doing an activity. The researcher should stimulate the user to make observations and give explanations of what he is doing and by, and how that fits into his life. For example, the user can draw maps and paths he takes through the spaces on the maps. The researchers or designers involved can also draw maps, and/or talk through the maps with the user. They can take photos or make video-recordings. This way, during the course of the research conducted by the researcher, the user is trained and prepared to later do such a study himself (a self-study).

In any case, the researcher should explain in detail how the research process should work and what is expected from the user. It is highly preferred to provide the user with a toolkit to help him in reporting his results of the self-study. The toolkit may contain items such as:

Blank paper to draw maps on,

Post-It® notes, colored paper,

Colored pens,

A diary, preferably in the form of loose paper or colored cards,

A scrapbook,

Tape and/or glue,

A box or bag to put objects in,

A disposable camera,

Audiocassettes and a cassette player, or

A telephone number to call in case they need assistance.

With these items the users should be able to easily keep track of the things he does during the self-study, which allows him to easily reconstruct his activities and the context in which they took place later. There should be sufficient material to allow the user to keep track for the entire self-study period, which preferably is one week. Of course, the exact period depends highly on the nature of the research subject, the number of users and so on.

Deep research path

As an alternative to step 103, the deep research path of steps 104 and 105 can be used. Step 104 comprises collecting background information about the user's relationship with the research subject. This is a relatively short period (maybe two or three hours) spent with the user to start to establish a relationship with the user and to find out about the user's views about the research subject.

For example, the user can be asked to draw up an initial map about their contexts of use regarding the research subject. The researcher could hold an informal interview, take photos or make video-recordings and so on. The user can be provided with the toolkit as described above. This step is similar to step 103, but should be more general and more aimed towards background information and preparation.

Having completed step 104, the subsequent step 105 comprises spending an extended period of time with the user to conduct the research and to prepare the user to perform the self-study. This extended period of time preferably is one day, so that the researcher gets to experience “a day in the life of . . . ”. The researcher should remain passive as much as possible and focus on the activities performed by the user. Of course the researcher may want to encourage the user to draw maps and paths they take through the spaces, collect artifacts he encounters during the activities he performs, and so on. The researcher could take photos or make video-recordings, or ask the user to do this.

By the end of this session, the user should feel confident about his ability to perform the research himself over a certain period of time (for example, a week). The researcher should provide a telephone number or other contact information for the user in case he encounters any unexpected issues during the self-study or just needs reassurance.

### USER SELF-STUDY

After the users have been trained in performing the self-study, they are given the opportunity to actually perform the self-study in step 106. The aim of the self-study is that the participating users document their lives over a period of, say, one week with respect to the research subject. The intent of this is for the users to be able to tell “stories” later in various ways about their continued relationships and encounters with the research subject and the context of use.

The user can for instance:

take photos of things that are interesting to him,

create and/or update maps, indicating places, routes, meanings and so on,

collect objects such as boxes, pictures, flyers, or shopping lists and add them to the scrapbook,

keep a diary in written or spoken form (using the cassette player),

and so on.

### USER REPORTING

After the users have completed the self-study, in step 107 they are asked to report on their respective self-studies to the researchers and designers. Preferably the respective reports are received in the form of narratives told by the users, based on the information and objects they have collected during their self-study. For instance, a user can take a map of the city in which he lives, draw the routes he took during the self-study period and place the photos, audiovisual recordings, drawings, notes and maps created he created or collected on the map along these routes.

The researchers and designers try to identify any problems encountered by the user and (possible) solutions identified or even used during the self-study. One option is to ask the user to describe an “ideal day” with respect to the research subject. The researchers and designers are free to add their own thoughts and ideas to the analysis, but they should clearly distinguish those from the information received from the users.

Optionally, the user can be asked to give feedback about the research process itself. He could also be given an incentive or present as a reward for participating in the research. It is recommended to perform a follow-up interview with the users some time after the respective reports have been received. This follow-up interview is intended to ask outstanding questions, or new questions that arose later, and to tie up any loose ends. It could for instance be held over the phone. One purpose of the follow-up interview is to keep the user involved in the process and to maintain or build up a long-term relationship with the user.

### CREATING THE COU MATRIX

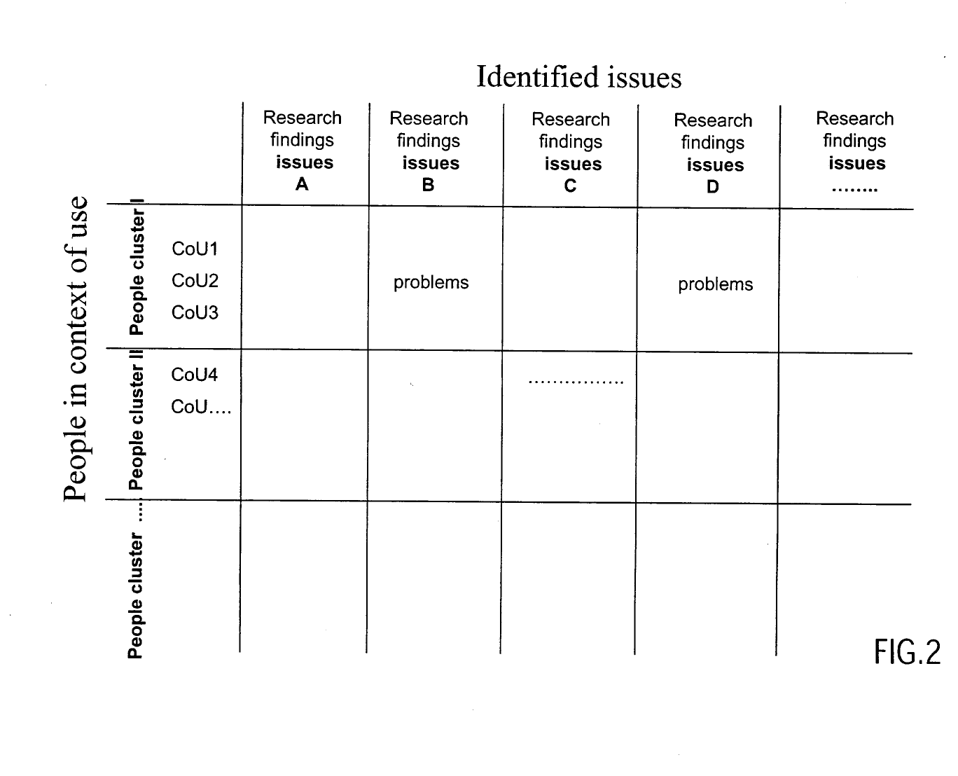

In step 108 the researchers produce a matrix called the Context of Use (CoU) matrix, linking issues identified in the previous steps to people clusters derived from characteristics of the individual persons. This matrix is shown in FIG. 2. The CoU matrix is a tool that allows the researchers to organize and communicate the research findings in order to:

link the general issues to the people clusters

compare the problems identified across issues and people clusters

summarize the potential market opportunities

In order to identify similar or different problems occurring across issues for one or more people clusters, we need to map the problems for each issues/people-clusters/contexts-of-use combination and to examine them for commonalities and differences.

Commonalities reveal potential market opportunity areas for improvement of current solutions and exploitation of new ones. Differences show us the potential for developing customized solutions for the different contexts-of-use.

The information from the respective reports is preferably grouped into categories for actors, activities, actions and artifacts. This provides a useful basis for the creation of the matrix.

And finally, in step 109 the new market opportunities are derived by comparing the problems identified across the linked issues and people clusters in the matrix. This preferably involves the researchers, designers and the individual persons working together as a team. The method produces a useful, concrete and tangible result in the form of this matrix, as well as in the newly identified gaps in the market for new products, new services or combinations thereof.

### DESCRIPTION OF AN ILLUSTRATIVE EMBODIMENT

An example of how the method according to the invention can be used in practice will now be given. In this illustrative example, the field of application selected was food and reduced access to food (delivery, preparation and consumption), in particular in relationship to elderly people. Some general research issues are:

the number of elderly people in the Netherlands is increasing, the work force is getting older and the number of people over 80 years of age is growing constantly;

at the same time, there is an increasing migration movement within the European Union and also form outside of Europe;

the different nutritional needs and expectations and culinary habits of these groups will provide an important challenge as well as a great opportunity for the next market solutions.

After the subject of the research has been identified, several participating users were contacted. At a macro level, broad socio-demographic forces (e.g. elderly and immigrants) were identified that became our samples for the implementation of the analysis to be conducted at micro level (user in his/her context of use). The identification of current socio-demographic forces seem an important element for consideration since it gives an insight concerning market orientation.

The researchers have decided to look at the user, either in the home (self-organized context) and in a community environment (institutionalized context). The consideration of these two different scales can facilitate a better understanding of user needs and wants either for the generation of new product-service solutions, or for the creation of new scenarios of use (e.g. different forms of shops, community-centers, restaurants) more sustainable than the existing ones.

The flexibility of this research method is illustrated by two case studies we carried out. In the first study, that of a French woman living in the Netherlands, the broad research path was used as the research participant's solution to her problem of not easily obtaining the food to which she was used, was to travel to France to buy it there. Instead of the researchers spending the day with her in France, she agreed to do very extensive research herself during her trip. For this case study, while we explored the research subject's relationships to food in general, the main focus was on this particular problem and the solutions that she had developed.

For the second case study, that of an elderly man living alone, the in-depth research method was used. The knowledge that we obtained from this research path was of the more general role of food in his life. In both case studies, we obtained varied and multimedia knowledge about the participant's everyday lives, their problems surrounding food delivery, access and consumption, and the solutions which they had generated themselves

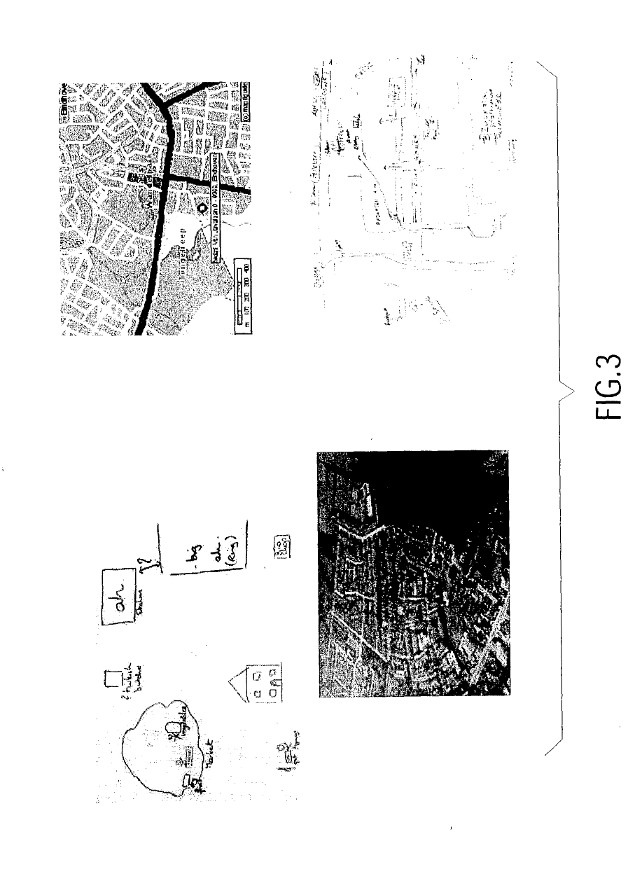

The researchers have used space and the user's passage through it in the course of a typical day to focus the research, to analyze the findings and to communicate the information. At the center of this focus are maps of physical, psychological and socio-cultural spaces that are associated with food. The maps don't have to be artistic or complex. It is easiest to draw maps of physical spaces and use these for the user to explain the psychological and socio-cultural influences in their food activities and relationships. FIG. 3 shows some of the maps drawn and used by the users in telling their stories.

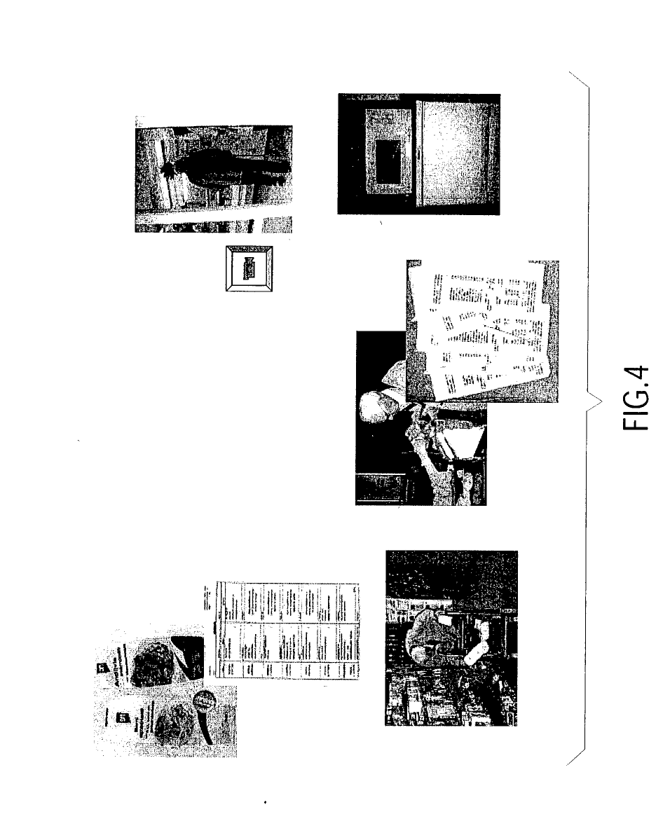

FIG. 4 illustrates an example report of a “day in the life of” a user. In this example report, there are several photos of the user while going to a supermarket to buy food products, and subsequent preparing his meal using the products he bought. A video recording was also made. This video recording could for example be presented by the user while making his report. Also included are the shopping list and the receipts given to the user by the cashier.

It is not enough to just ask questions. To get at the hidden and exceptional needs of a user, other measures have to be taken. This research framework deals with this by:

spending an extended time with the user (a day in the life or doing an activity),

observing what they do and asking for explanations,

having the user track exceptions to the everyday life, and/or

asking for the user's idea of an ideal day with respect to food.

Within this framework, specific research questions can be addressed. These are just a few suggestions—of course, many more can be formulated.

The results of the reports can be used to create a matrix in which a comparison is made between various users. A distinction could be made based on e.g. fresh or ready to eat food and tools used to prepare said food, or on the means used to obtain food (car, rollator, bicycle), the places where to obtain food (supermarket, butcher, marketplace) or the means used to consume the food (expensive cutlery, plastic containers).

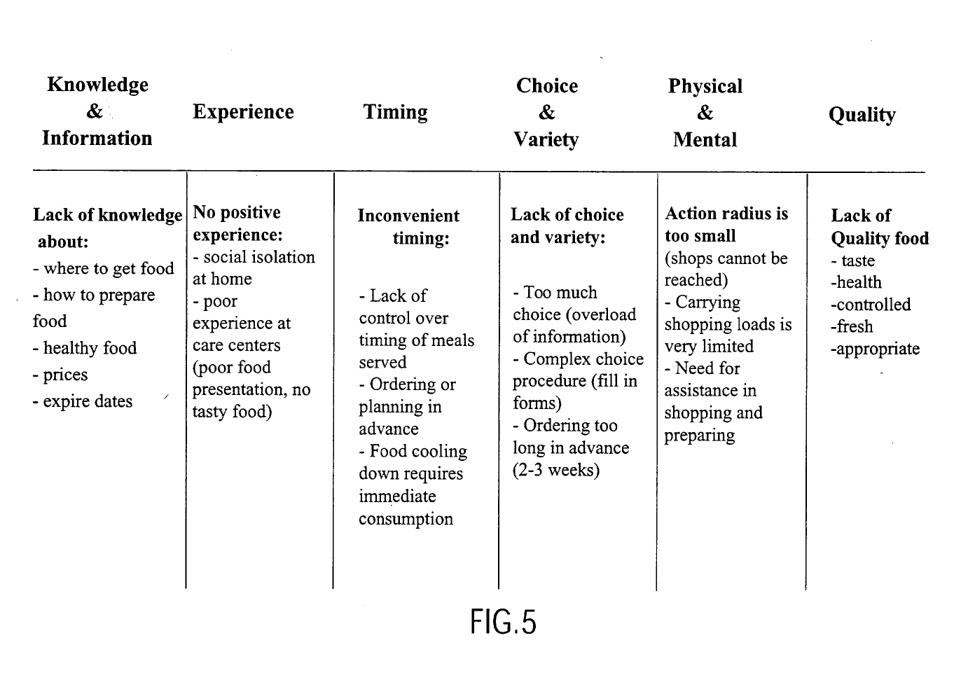

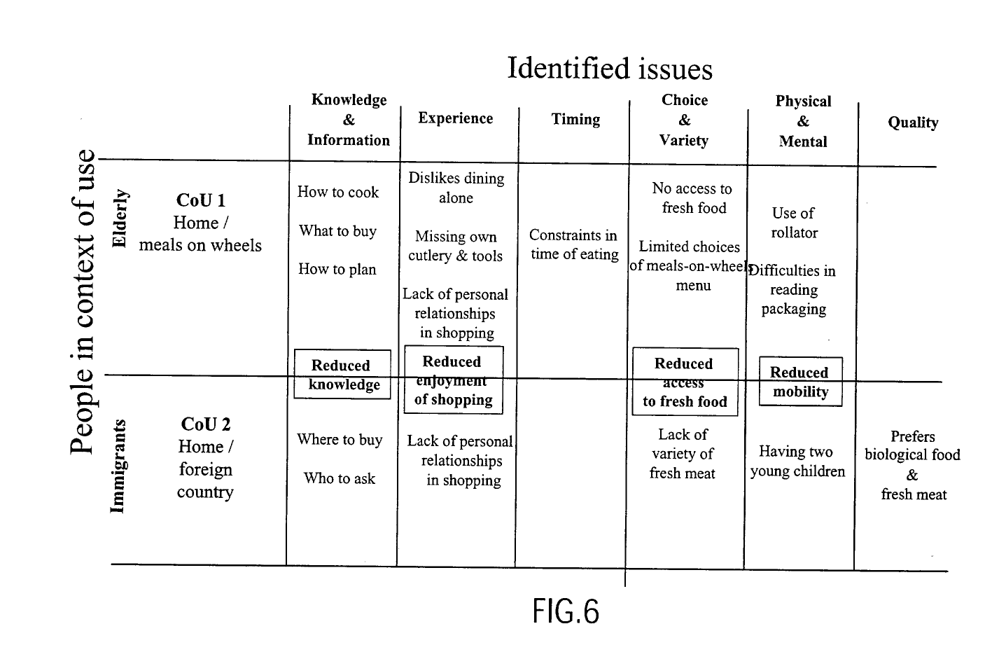

FIG. 5 shows example issues obtained through the reports made by users. FIG. 6 shows how the example issues of FIG. 5 can be presented in the CoU matrix of FIG. 2 to facilitate easy comparison of data and derivation of market opportunities.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A method of identifying new market opportunities, comprising
determining a subject for research based on the market in which said opportunities are to be identified,
inviting individual persons to participate in the research regarding the subject,
training the individual persons to perform a self-study regarding the subject,
letting the individual persons perform the self-study for a certain period of time,
receiving respective reports from the individual persons on their respective self-studies in specific places at specific times,
producing a matrix linking issues identified in the previous steps to people clusters derived from characteristics of the individual persons in the specific places and at the specific times, and
deriving the new market opportunities by comparing the problems identified across the linked issues and people clusters in the matrix.

2. The method of claim 1, in which the training comprises spending a period of time with the user to prepare the user to perform the self-study, focusing on one or more activities related to the subject.

3. The method of claim 1, in which the training comprises collecting background information about the user's relationship with the subject, and spending an extended period of time with the user to prepare the user to perform the self-study.

4. The method of claim 1, in which the respective reports are received in the form of narratives told by the individual persons.

5. The method of claim 4, in which the respective reports comprise documentation collected during the certain period of time in which the self-study was performed.

6. The method of claim 5, in which said documentation includes photos, audiovisual recordings, drawings, notes and maps created by the individual persons and objects collected by the individual persons during the certain period of time in which the self-study was performed.

7. The method of claim 1, in which the information from the respective reports are grouped into categories for actors, activities, actions and artifacts.

8. The method of claim 1, involving researchers, designers and the individual persons working together as a team to identify the new market opportunities.

9. The method of claim 1, further comprising rewarding the individual persons for their participation.

10. The method of claim 1, further comprising performing a follow-up interview with the individual persons some time after the respective reports have been received.
